(19) United States
(12) Patent Application Publication
(10) Pub. No.: US 2004/0159040 A1
(43) Pub. Date: Aug. 19, 2004

(54) Mosquito trap

(76) Inventor: Chung Ming Chen, Taipei (TW)

Correspondence Address: BACON & THOMAS, PLLC, 625 SLATERS LANE, FOURTH FLOOR, ALEXANDRIA, VA, 22314

(21) Appl. No.: 10/365,463

(22) Filed: Feb. 13, 2003

(51) Int. Cl. A01M 1/22; H05C 3/00

(52) U.S. Cl. 43/112

(57) ABSTRACT

A mosquito trap includes a lower housing, a fan holder mounted on the lower housing for sequentially holding a lamp holder and a fan to a top of the fan holder, a lamp connected to the lamp holder, a high-tension screen connected to the lamp holder to enclose the lamp therein, a winding means provided below the fan holder for a power cord to wind therearound, and a lampshade connected to the lower housing to enclose the fan holder, the fan, the lamp holder, the lamp, and the high-tension screen therein. The lamp emits light to induce mosquitoes and the fan produces a suction flow to suck surrounding mosquitoes to the high-tension screen, at where the trapped mosquitoes are killed by a high tension A bottom cap provided at a bottom of the lower housing can be opened to dump bodies of killed mosquitoes conveniently.

### FIELD OF THE INVENTION

The present invention relates to a mosquito trap having a lower housing with a bottom cap, a fan holder mounted in the lower housing for holding a lamp holder and a fan thereto, a lamp fixed to the lamp holder and enclosed in a high-tension screen, a winding means provided below the fan holder, and a lampshade assembled to a top of the lower housing to enclose the fan holder, the fan, the lamp holder, the lamp, and the high-tension screen therein.

### BACKGROUND OF THE INVENTION

A conventional mosquito trap is designed based on the phototaxis of mosquito and generally includes a high-tension screen and a lamp. The lamp emits light to induce the mosquito to fly toward the trap and the high-tension screen produces a high tension to shock the mosquito flown thereto. The above-described mosquito trap has low rate of trapping. Most mosquitoes are induced toward the light to fly around the trap but not killed by the high-tension screen. There is also a conventional mosquito trap using a suction fan to suck mosquitoes into a closed chamber. A suction force produced by the suction fan effects only within a limited range and is completely useless if there is not an inducement for the mosquitoes to fly close to the trap.

It is therefore tried by the inventor to develop an improved mosquito trap to eliminate the drawbacks existed in the mosquito trap of prior art.

### SUMMARY OF THE INVENTION

A primary object of the present invention is to provide a mosquito trap that uses a fan to produce a strong suction flow for sucking mosquitoes into a high-tension screen, at where the sucked mosquitoes are killed by a high-tension current.

Another object of the present invention is to provide a mosquito trap that has a bottom cap provided at a lower housing to facilitate convenient dumping of mosquito bodies to clear off the mosquito trap.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a mosquito trap according to the present invention;

FIG. 2 is a bottom perspective view of an annular base and a lower housing of the mosquito trap of FIG. 1 in a separated state;

FIG. 3 is an assembled perspective view of the mosquito trap of FIG. 1;

FIG. 4 shows the mosquito trap of the present invention is electrically made to emit light and produce a suction flow;

FIG. 5 shows the electrically made mosquito trap of the present invention induces mosquitoes to fly toward it;

FIG. 6 shows the mosquito trap of the present invention functions to kill mosquitoes with high tension;

FIG. 7 shows a bottom cap is opened to clear off the lower housing;

FIG. 8 is a bottom view of the present invention showing a power cord thereof is pulled outward for connecting to a power supply; and

FIG. 9 shows a rocking handle provided at a bottom of the present invention is turned to rewind the power cord.

### DETAILED DESCRIPTION OF THE PREFERRED EMBODIMENTS

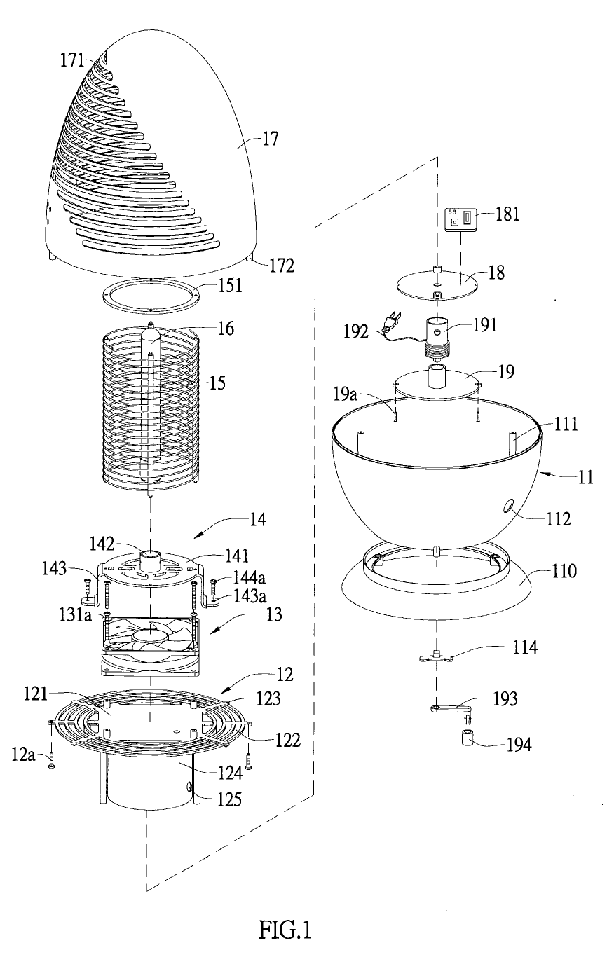

Please refer to FIGS. 1, 2, 3, and 4. A mosquito trap according to the present invention mainly includes from bottom to top a lower housing 11, a fan holder 12, a fan 13, a lamp holder 14, a high-tension screen 15, a lamp 16, and a lampshade 17.

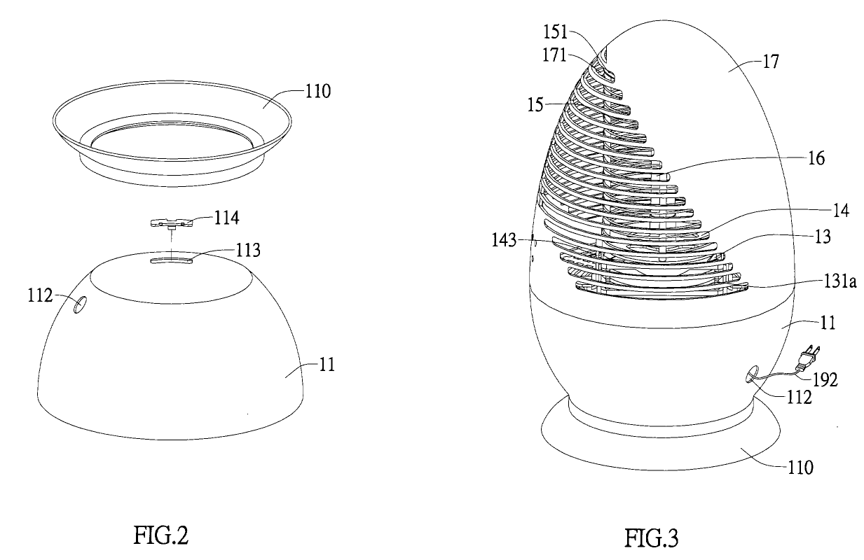

The lower housing is provided on an inner wall surface with a plurality of upward extended supporting ribs 111, at one side with a first through hole 112, and at a bottom with a second through hole 113 openably closed by a bottom cap 114 (see FIG. 2). An annular base 110 is assembled to the bottom of the lower housing 11.

The fan holder 12 has a fixed central platform 121 having a plurality of radially outward extended supporting bars 123, a plurality of openings 122 located between two adjacent supporting bars 123 to extend around the central platform 121, and a hollow cylinder 124 fixedly connected below the platform 121. The hollow cylinder 124 is provided at one side with a third through hole 125. The fan 13 is fixedly mounted on a top of the platform 121 to produce a suction flow to suck in mosquitoes flying around the mosquito trap. A wiring board holder 18 and a bottom plate 19 for the fan holder are provided in the cylinder 124.

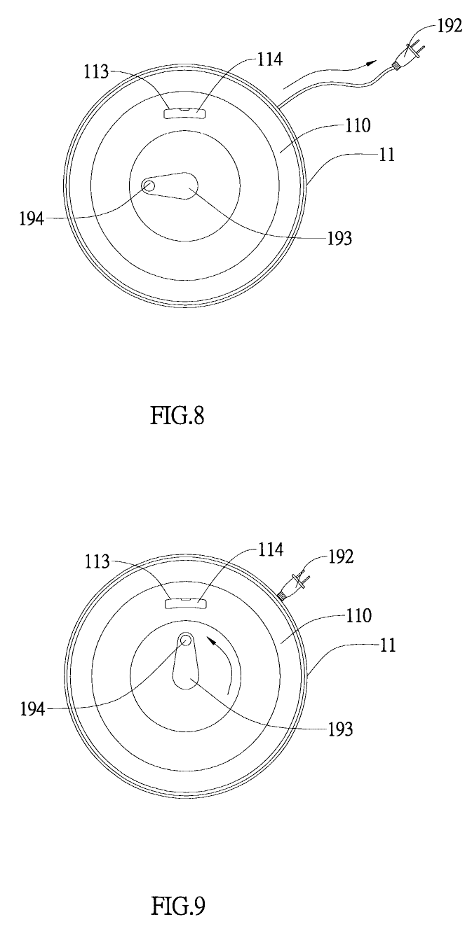

A wiring board 181 is fixedly mounted on the wiring board holder 18. The bottom plate 19 has a rotor 191 connected thereto. A power cord 192 is wound around the rotor 191. A rocking handle 193 is provided at an underside of the bottom plate 19 (see FIGS. 8 and 9) and connected to the rotor 191. A handle sleeve 194 is mounted on the rocking handle 193 to facilitate easy turning of the rocking handle 193.

The lamp holder 14 includes a flat plate 141 having a fixing member 142 centered at a top thereof. Two fastening lugs 143 with internally threaded holes 143a are provided at two opposite points of the flat plate 141. The high-tension screen 15 and the lamp 16 are located on the lamp holder 14. A fixing ring 151 is connected to an upper end of the high-tension screen 15. The lamp 16 can emit light to induce mosquitoes to fly toward the mosquito trap.

The lampshade 17 is provided on an inner wall surface with a plurality of downward extended fastening ribs 172. A plurality of elongated openings 171 are formed on one side of the lampshade 17, so that the suction flow produced by the fan 13 may be concentrated in the lampshade 17.

To assemble the mosquito trap of the present invention, first fix the wiring board 181 to the wiring board holder 18, which is then mounted in the hollow cylinder 124 of the fan holder 12. Thereafter, the bottom plate 19 having the rotor 191 connected thereto is fastened to the cylinder 124 of the fan holder 12 by means of screwing elements 19a. Then, fasten the fan 13 to the platform 121 of the fan holder 12 by means of screwing elements 131a, and the lamp holder 14 to the fan holder 12 above the fan 13 by means of screwing elements 144a extended through the threaded holes 143a on the fastening lugs 143. Then, connect the lamp 16 to the fixing member 142 on the flat plate 141 of the lamp holder 14, and mount the fixing ring 151 to an upper end of the high-tension screen 15 before connecting the latter to the top of the flat plate 141 of the lamp holder 14, so that the lamp 16 is enclosed in the high-tension screen 15. Thereafter, fasten the lampshade 17 to the fan holder 12 by upward extending screwing elements 12a into the fastening ribs 172 on the innerwall surface of the lampshade 17. Finally, position the lampshade 17 on the lower housing 11 with the supporting bars 123 on the fan holder 12 rested on tops of the supporting ribs 111 provided on the inner wall surface of the lower housing 11. The power cord 192 wound around the rotor 191 may be sequentially pulled through the third through hole 125 on the cylinder 124 of the fan holder 12 and the first through hole 112 on the lower housing 11 to expose from the lower housing 11. The lower housing 11 is then assembled onto the annular base 110 to complete the mosquito trap of the present invention.

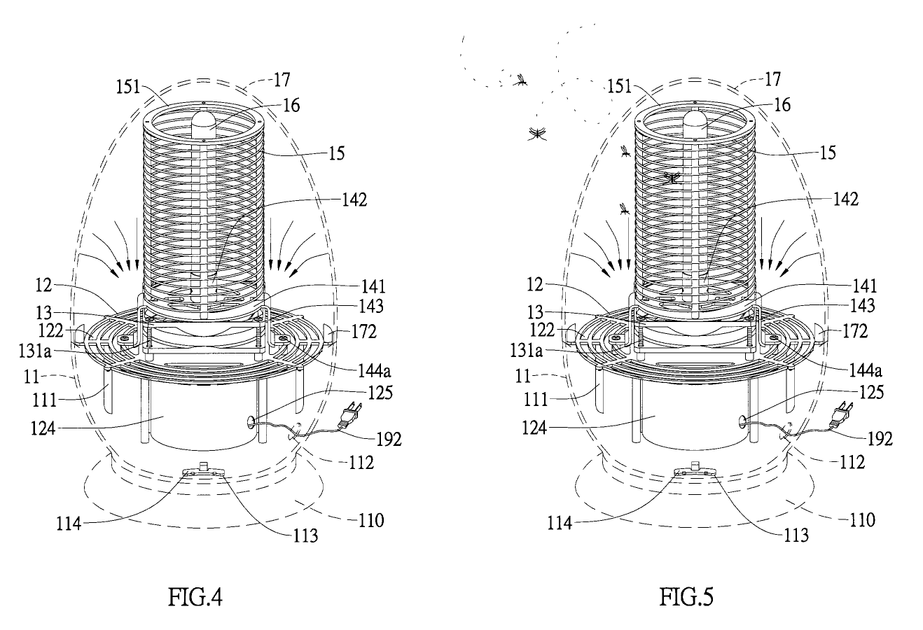

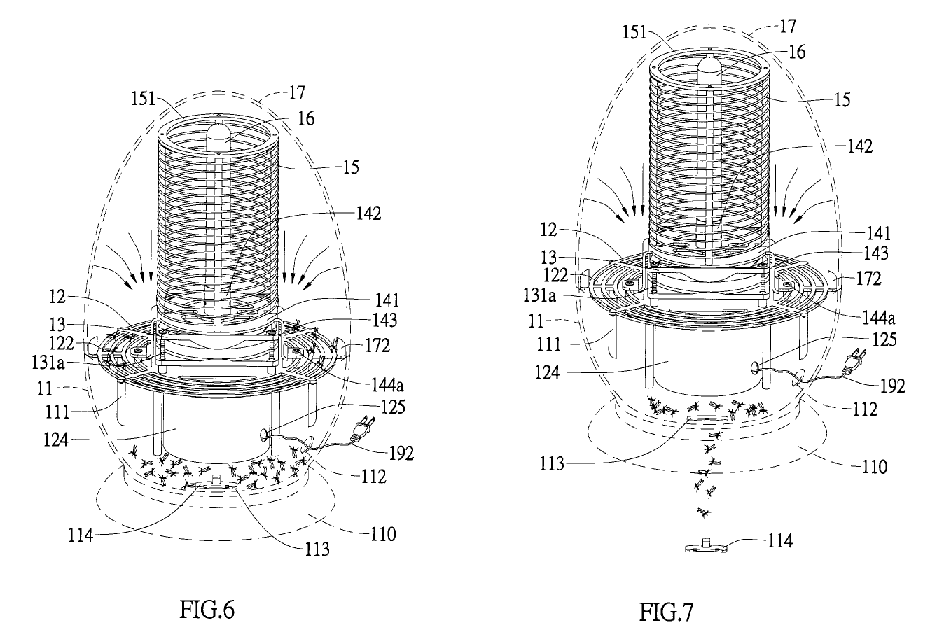

Please refer to FIGS. 4, 5, 6, and 7. When the mosquito trap of the present invention is connected to a power supply and turned on, the lamp 16, the high-tension screen 15, and the fan 13 are electrically made at the same time. Mosquitoes induced by the light emitted from the lamp 16 to fly around the lampshade 17 would be sucked into the strong suction flow produced by the rotating fan 13 and attached to the high-tension screen 15. A high tension generated by the high-tension screen 15 is strong enough to kill the mosquitoes. Bodies of the killed mosquitoes are sucked by the suction flow produced by the fan 13 to pass the openings 122 on the fan holder 12 and fall to the bottom of the lower housing 11. To clear off the lower housing 11, simply remove the bottom cap 114 to open the second through hole 113 at the bottom of the lower housing 11, and dump the mosquito bodies.

Please refer to FIGS. 1, 8, and 9. The power cord 192 is wound around the rotor 191. To connect the power cord 192 to an external power source, simply pull the power cord 192 outward by a suitable length to reach the power source. And, to collect the outward pulled power cord 192, simply turn the rocking handle 193 at the handle sleeve 194 to rotate the rotor 191 and thereby rewind the power cord 192 around the rotor 191, so that the power cord 192 is located in the cylinder 124 of the fan holder 12 again.

With the above arrangements, the mosquito trap of the present invention not only has effectively upgraded mosquito-trapping function, but also can be conveniently and easily cleared off. Moreover, the power cord thereof could be pulled out for use and rewound for storage. in a more convenient manner.

The present invention has been described with a preferred embodiment thereof and it is understood that many changes and modifications in the described embodiment can be carried out without departing from the scope and the spirit of the invention as defined by the appended claims.

What is claimed is:

1. A mosquito trap, comprising a lower housing, a fan holder mounted on said lower housing for sequentially holding a lamp holder and a fan to a top of said fan holder, a lamp connected to said lamp holder, a high-tension screen connected to said lamp holder to enclose said lamp therein, a winding means provided below said fan holder for a power cord to wind therearound, and a lampshade connected to said lower housing to enclose said fan holder, said fan, said lamp holder, said lamp, and said high-tension screen therein; whereby when said power cord is pulled outward to connect to a power source, said lamp emits light to induce mosquitoes and said fan produces a suction flow to suck surrounding mosquitoes to said high-tension screen that kills the trapped mosquitoes with a high tension; and when a bottom cap provided at a bottom of said lower housing is opened, bodies of killed mosquitoes can be dumped to clear off said lower housing.

2. The mosquito trap as claimed in claim 1, wherein said winding means comprises a wiring board holder, a rotor, and a bottom plate connected to a bottom of said fan holder.

3. The mosquito trap as claimed in claim 2, wherein said rotor is connected to a rocking handle, so that said rotor is rotated via turning of said rocking handle.

4. The mosquito trap as claimed in claim 1, wherein said lower housing is connected to a top of an annular base for said lower housing to stably locate on a surface.

5. The mosquito trap as claimed in claim 1, wherein said lampshade is provided at only one side with a plurality of elongated openings to enable concentration of said suction flow produced by said fan in said lampshade.
